(19) United States
(12) Patent Application Publication
(10) Pub. No.: US 2020/0264718 A1
(43) Pub. Date: Aug. 20, 2020

(54) EMBEDDED TOUCH DISPLAY PANEL AND DISPLAY DEVICE

(71) Applicant: WUHAN CHINA STAR OPTOELECTRONICS TECHNOLOGY CO., LTD., Wuhan (CN)

(72) Inventors: Yuejun TANG, Wuhan (CN); Xueyun LI, Wuhan (CN)

(73) Assignee: WUHAN CHINA STAR OPTOELECTRONICS TECHNOLOGY CO, LTD., Wuhan (CN)

(21) Appl. No.: 16/349,294

(22) PCT Filed: Jan. 22, 2019
(86) PCT No.: PCT/CN2019/072721

§ 371 Date: May 13, 2019

(30) Foreign Application Priority Data
Oct. 31, 2018 (CN) 201811282767.2

(51) Int. Cl. G06F 3/047; G06F 3/041; G02F 1/1362

(52) U.S. Cl. CPC G06F 3/047; G06F 3/0412; G02F 1/136209; G02F 2001/136295; G02F 1/136227; G06F 2203/04103; G02F 1/136286

(57) ABSTRACT

An embedded touch display panel and display device are provided including a substrate, a light shielding metal layer, and a light shielding metal layer disposed on the substrate. The light shielding metal layer includes a light shielding metal and touch wires. A multiplexing electrode layer is disposed on the light shielding metal layer, and the multiplexing electrode layer includes a plurality of multiplexing metal pieces. The multiplexing metal pieces are electrically connected to the touch wires.

### FIELD OF INVENTION

The present invention relates to a field of displays, especially to an embedded touch display panel and a display device.

### BACKGROUND OF INVENTION

In a conventional embedded touch display panel, touch wires are usually formed by a new added metal layer or made by a same process that manufacturing a source and drain electrode same layer material. However, these two methods both have shortages of increased masks and lowered pixel aperture ratio.

Therefore, defects existing in prior art need to be fixed immediately.

### SUMMARY OF INVENTION

### Technical Issue

An objective of an embodiment of the present invention is to provide an embedded touch display panel and an electronic device that can solve the issue of exceeded masks and low pixel aperture ratio during formation of touch wires.

### Technical Solution

The embodiment of the present invention provides an embedded touch display panel, comprising:

a substrate;

a light shielding metal layer, the light shielding metal layer disposed on the substrate, and the light shielding metal layer comprising a light shielding metal and a plurality of touch wires; and

a multiplexing electrode layer, the multiplexing electrode layer disposed on the light shielding metal layer, and the multiplexing electrode layer comprising a plurality of multiplexing metal pieces, and the multiplexing metal pieces electrically connected to the touch wires respectively; and

wherein a first insulation layer, a transistor layer and a second insulation layer are disposed between the light shielding metal layer and the multiplexing electrode layer, and are sequentially stacked upon one another;

wherein a plurality of first via holes are defined in the first insulation layer, a plurality of second via holes are defined in the transistor layer, a plurality of third via holes are defined in the second insulation layer, and each of the multiplexing metal pieces is electrically connected to a corresponding one of the touch wires through one of the first via holes, one of the second via holes and one of the third via holes; and

wherein the embedded touch display panel further comprises a plurality of scan lines and a plurality of data lines, and the touch wires are disposed right under the scan lines or the data lines.

In the embedded touch display panel of the present invention, the multiplexing metal pieces extend in the first via holes, the second via holes, and the third via holes and are electrically connected to the touch wires respectively.

In the embedded touch display panel of the present invention, the first via holes, the second via holes and the third via holes are arranged coaxially.

In the embedded touch display panel of the present invention, the transistor layer comprises a conductive channel sub-layer, a third insulation sub-layer, a gate electrode metal sub-layer, a fourth insulation sub-layer, and a source/drain electrode metal sub-layer that are sequentially stacked upon one another; and

the conductive channel sub-layer is configured to form a conductive channel of a transistor, the gate electrode metal sub-layer is configured to form a gate electrode of the transistor, the source/drain electrode metal sub-layer is configured to form a source electrode and a drain electrode of the transistor; and the light shielding metal is located right under the transistor.

In the embedded touch display panel of the present invention, the source/drain electrode metal sub-layer is further configured to form a plurality of first connection electrodes, the first connection electrodes extend in the second via holes and the first via holes, and are electrically connected to the touch wires respectively; and

the multiplexing metal pieces extend in the third via holes, and are electrically connected to the first connection electrodes respectively.

In the embedded touch display panel of the present invention, the first via holes and the second via holes are arranged coaxially, and the first via holes and the second via holes are arranged non-coaxially.

The embodiment of the present invention also provides an embedded touch display panel comprising:

a substrate;

a light shielding metal layer, the light shielding metal layer disposed on the substrate, and the light shielding metal layer comprising a light shielding metal and a plurality of touch wires; and

a multiplexing electrode layer, the multiplexing electrode layer disposed on the light shielding metal layer, and the multiplexing electrode layer comprising a plurality of multiplexing metal pieces, and the multiplexing metal pieces electrically connected to the touch wires respectively.

In the embedded touch display panel of the present invention, a first insulation layer, a transistor layer and a second insulation layer are disposed between the light shielding metal layer and the multiplexing electrode layer, and are sequentially stacked upon one another; and

a plurality of first via holes are defined in the first insulation layer, a plurality of second via holes are defined in the transistor layer, a plurality of third via holes are defined in the second insulation layer, and each of the multiplexing metal pieces is electrically connected to a corresponding one of the touch wires through one of the first via holes, one of the second via holes and one of the third via holes.

In the embedded touch display panel of the present invention, the multiplexing metal pieces extend in the first via holes, the second via holes, and the third via holes and are electrically connected to the touch wires respectively.

In the embedded touch display panel of the present invention, the first via holes, the second via holes and the third via holes are arranged coaxially.

In the embedded touch display panel of the present invention, the transistor layer comprises a conductive channel sub-layer, a third insulation sub-layer, a gate electrode metal sub-layer, a fourth insulation sub-layer, and a source/drain electrode metal sub-layer that are sequentially stacked upon one another; and

the conductive channel sub-layer is configured to form a conductive channel of a transistor, the gate electrode metal sub-layer is configured to form a gate electrode of the transistor, the source/drain electrode metal sub-layer is configured to form a source electrode and a drain electrode of the transistor; and the light shielding metal is located right under the transistor.

In the embedded touch display panel of the present invention, the source/drain electrode metal sub-layer is further configured to form a plurality of first connection electrodes, the first connection electrodes extend in the second via holes and the first via holes, and are electrically connected to the touch wires respectively; and

the multiplexing metal pieces extend in the third via holes, and are electrically connected to the first connection electrodes respectively.

In the embedded touch display panel of the present invention, the first via holes and the second via holes are arranged coaxially, and the first via holes and the second via holes are arranged non-coaxially.

In the embedded touch display panel of the present invention, the second via holes comprise a plurality of first sub-via holes and a plurality of second sub-via holes, the first sub-via holes are defined in the third insulation sub-layer, the second sub-via holes are defined in the fourth insulation sub-layer; and

each of the multiplexing metal pieces is electrically connected to a corresponding one of the touch wires through the first via holes, the first sub-via holes, the second sub-via holes and the third via holes.

In the embedded touch display panel of the present invention, the source/drain electrode metal sub-layer is further configured to form a plurality of second connection electrodes, and the gate electrode metal sub-layer is further configured to form a plurality of third connection electrodes;

the second connection electrodes extend in the second sub-via holes and are electrically connected to the third connection electrodes, and the third connection electrodes extend in the first sub-via holes and are electrically connected to the touch wires respectively; and

the multiplexing metal pieces extend in the third via holes, and are electrically connected to the second connection electrodes.

In the embedded touch display panel of the present invention, the third via holes, the second sub-via holes and the first sub-via holes are arranged non-coaxially, and the first sub-via holes and the first via holes are arranged coaxially.

In the embedded touch display panel of the present invention, the embedded touch display panel further comprises a plurality of scan lines and a plurality of data lines; the touch wires are disposed right under the scan lines or the data lines.

In the embedded touch display panel of the present invention, the light shielding metal is insulated from the touch wires.

In the embedded touch display panel of the present invention, the light shielding metal is electrically connected to some of the touch wires.

The embodiment of the present invention also provides a display device comprising an embedded touch display panel, and the embedded touch display panel, comprises:

a substrate;

a light shielding metal layer, the light shielding metal layer disposed on the substrate, and the light shielding metal layer comprising a light shielding metal and a plurality of touch wires; and

a multiplexing electrode layer, the multiplexing electrode layer disposed on the light shielding metal layer, and the multiplexing electrode layer comprising a plurality of multiplexing metal pieces, and the multiplexing metal pieces electrically connected to the touch wires respectively.

Advantages

The embedded touch display panel and the display device provided by the present invention comprise: a substrate; a light shielding metal layer, the light shielding metal layer disposed on the substrate, the light shielding metal layer comprising a light shielding metal and a plurality of touch wires; and multiplexing electrode layer, the multiplexing electrode layer disposed on light shielding metal layer, and the multiplexing electrode layer comprises a plurality of multiplexing metal pieces, the plurality of multiplexing metal pieces electrically connected to a plurality of touch wires respectively. The present invention, by disposing the touch wires and the light shielding metal on the same player, reduces a number of masks during formation of the touch wires. The present invention also disposes the touch wires right under scan lines or data lines to raise pixel aperture ratio.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a first schematic structural view of an embodiment of an embedded touch display panel of the present invention;

FIG. 2 is a second schematic structural view of the embodiment of the embedded touch display panel of the present invention;

FIG. 3 is a third schematic structural view of the embodiment of the embedded touch display panel of the present invention;

FIG. 4 is a first schematic structural view of a wire layout structure of the embodiment of the embedded touch display panel of the present invention;

FIG. 5 is a second schematic structural view of a wire layout structure of the embodiment of the embedded touch display panel of the present invention;

FIG. 6 is a third schematic structural view of a wire layout structure of the embodiment of the embedded touch display panel of the present invention; and

FIG. 7 is a fourth schematic structural view of a wire layout structure of the embodiment of the embedded touch display panel of the present invention.

### DETAILED DESCRIPTION OF PREFERRED EMBODIMENTS

Embodiments of the present invention will be described in details. Examples of the embodiments are illustrated in the accompanying drawings. The same or similar reference characters refer to the same or similar elements or elements including the same or similar functions. The following embodiments described with reference to the accompanying drawings are exemplary, are only configured to construe the present invention and cannot be understood as limitations to the present invention.

In the description of the present invention, it should be understood that terminologies “center”, “longitudinal”, “transverse”, “length”, “width”, “thickness”, “upper”, “lower”, “front”, “rear”, “left”, “side”, “vertical”, “horizontal”, “top”, “bottom”, “inner”, “outer”, “clockwise”, “counterclockwise” for indicating relations of orientation or position are based on orientation or position of the accompanying drawings, are only for the purposes of facilitating description of the present invention and simplifying the description instead of indicating or implying that the referred device or element must have a specific orientation or position, must to be structured and operated with the specific orientation or position. Therefore, they should not be understood as limitations to the present invention. Furthermore, terminologies “first”, “second” are only for the purposes of description, and cannot be understood as indication or implication of comparative importance or a number of technical features. Therefore, a feature limited with “first”, “second” can expressly or implicitly include one or more features. In the description of the present invention, a meaning of “a plurality of” is two or more, unless there is a clear and specific limitation otherwise.

In the description of the present invention, it should be noted that unless clear rules and limitations otherwise exist, terminologies “install”, “connect”, “connection” should be understood in a broad sense. For instance, the connection can be a fixed connection, a detachable connection or an integral connection. The connection can be a mechanical connection, an electrical connection or a telecommunication. The connection can be a direct connection, an indirect connection through an intermedium, can be an internal communication between two elements or an interaction between the two elements. For a person of ordinary skill in the art, the specific meaning of the above terminology in the present invention can be understood on a case-by-case basis.

In the present invention, it should be noted that unless clear rules and limitations otherwise exist, words “a first feature is “on” or “under” a second feature” can include a direct contact of the first and second features, can also include a contact of the first and second features through another feature therebetween instead of a direct contact. Furthermore, words “the first feature is “above” or “over” the second feature include that the first feature is right above or obliquely above the second feature, or only indicate that a level of the first feature is higher that of the second feature. Words “the first feature is “under” or “below” the second feature include that the first feature is right under or obliquely under the second feature, or only indicate that the level of the first feature is lower than that of the second feature.

The following disclosure provides many different embodiments or examples to achieve different structures of the present invention. To simplify the disclosure of the present invention, the components and arrangements of the specific examples are described below. Of course, they are merely examples, and the purpose is not to limit the present invention. Furthermore, the present invention may repeat reference numerals and/or reference letters in different examples. The repetition is for the purpose of simplification and clarity, and does not by itself indicate the relationship between the various embodiments and/or settings discussed. In addition, the present invention provides examples of various specific processes and materials, but a person of ordinary skill in the art can be aware of the application of other processes and/or the use of other materials.

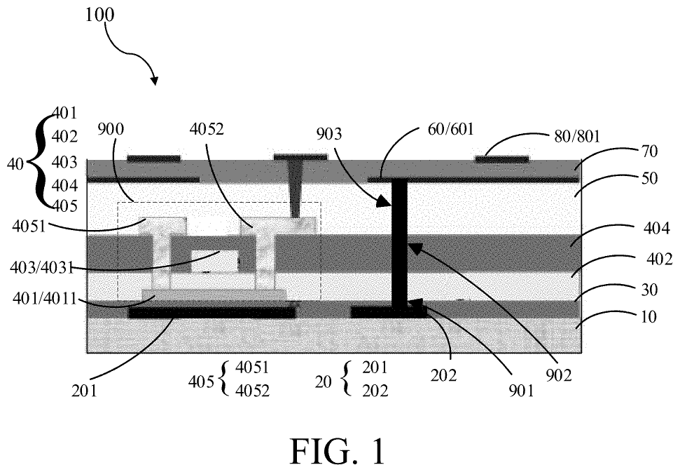

With reference to FIG. 1, FIG. 1 is a first schematic structural view of an embodiment of an embedded touch display panel of the present invention. As shown in FIG. 1, an embedded touch display panel 100 of the embodiment of the present invention includes a substrate 10, a light shielding metal layer 20, a first insulation layer 30, a transistor layer 40, a second insulation layer 50, a multiplexing electrode layer 60, a third insulation layer 70, and a pixel electrode layer 80. The light shielding metal layer 20, the first insulation layer 30, the transistor layer 40, the second insulation layer 50, the multiplexing electrode layer 60, the third insulation layer 70, and the pixel electrode 80 are sequentially staked upon the substrate 10. The pixel electrode layer 80 includes a plurality of pixel electrode 801.

In an embodiment of the present invention, the light shielding metal layer 20 includes a light shielding metal 201 and a plurality of touch wires 202. The light shielding metal 201 and the touch wires 202 are disposed on a same layer, the light shielding metal 201 can be formed simultaneously with the touch wires 202 such that a number of masks required for forming the touch wires 202 can be reduced. For instance, the embodiment of the present invention can form the light shielding metal layer 20 on the substrate 10, and then form the light shielding metal 201 and the touch wires 202 by a patterning process.

Furthermore, multiplexing electrode layer 60 includes a plurality of multiplexing metal pieces 601. The multiplexing metal pieces 601 are electrically connected to the touch wires 202 respectively. The multiplexing electrode layer 60 can be a common electrode layer. The embodiment of the present invention cuts the common electrode layer into a plurality of multiplexing metal pieces 601, and the multiplexing metal pieces 601 are electrically connected to a chip on the embedded touch display panel 100 through the plurality of touch wires 202.

In an embodiment, a plurality of first via holes 901 are disposed on the first insulation layer 30. A plurality of second via holes 902 are disposed on the transistor layer 40. A plurality of third via holes 903 are disposed on the second insulation layer 50. Each of the multiplexing metal pieces 601 is electrically connected to a corresponding one of touch wires 202 through one of the first via holes 901, one of the second via holes 902, and one of the third via holes 903. It can be understood that in the embodiment of the present invention, one multiplexing metal piece 601 corresponds to one touch wire 202. The multiplexing metal piece 601 is electrically connected to one touch wire 202 through one first via hole 901, one second via hole 902, and one third via hole 903.

The multiplexing metal pieces 601 extend in the first via holes 901, the second via holes 902, and the third via holes 903, and are electrically connected to the touch wires 202 respectively. It is understood that the first via holes 901, the second via holes 902, and the third via holes 903 are arranged coaxially.

For instance, an embodiment of the present invention forms a light shielding metal layer 20 on a substrate 10 first, and forms a light shielding metal 201 and a plurality of metal wires 202 by a patterning process. Then, a first insulation layer 30, a transistor layer 40, and a second insulation layer 50 are formed sequentially later, and first via holes 901, second via holes 902, and third via holes 903 are defined by an etching process; Finally, a multiplexing electrode layer 60 is formed, and a plurality of multiplexing metal pieces 601 are formed by a patterning process. Because each of the multiplexing metal pieces 601 corresponds to one first via hole 901, one second via hole 902, and one third via hole 903, therefore each of the multiplexing metal pieces 601 extends in the corresponding first via hole 901, the corresponding second via hole 902, and corresponding the third via hole 903 to achieve an electrical connection to a corresponding touch wire 202.

With reference to FIG. 1 again, in an embodiment, the transistor layer 40 comprises a conductive channel sub-layer 401, a third insulation sub-layer 402, a gate electrode metal sub-layer 403, a fourth insulation sub-layer 404, and a source/drain electrode metal sub-layer 405 that are sequentially stacked upon one another.

The conductive channel sub-layer 401 is configured to form a conductive channel 4011 of a transistor 900. The gate electrode metal sub-layer 403 is configured to a gate electrode 4031 of the transistor 900. The source/drain electrode metal sub-layer 405 is configured to form a source electrode 4051 and a drain electrode 4052 of the transistor 900. The third insulation sub-layer 402 and fourth insulation sub-layer 404 are both insulating layers. The light shielding metal 201 is located right under the transistor 900.

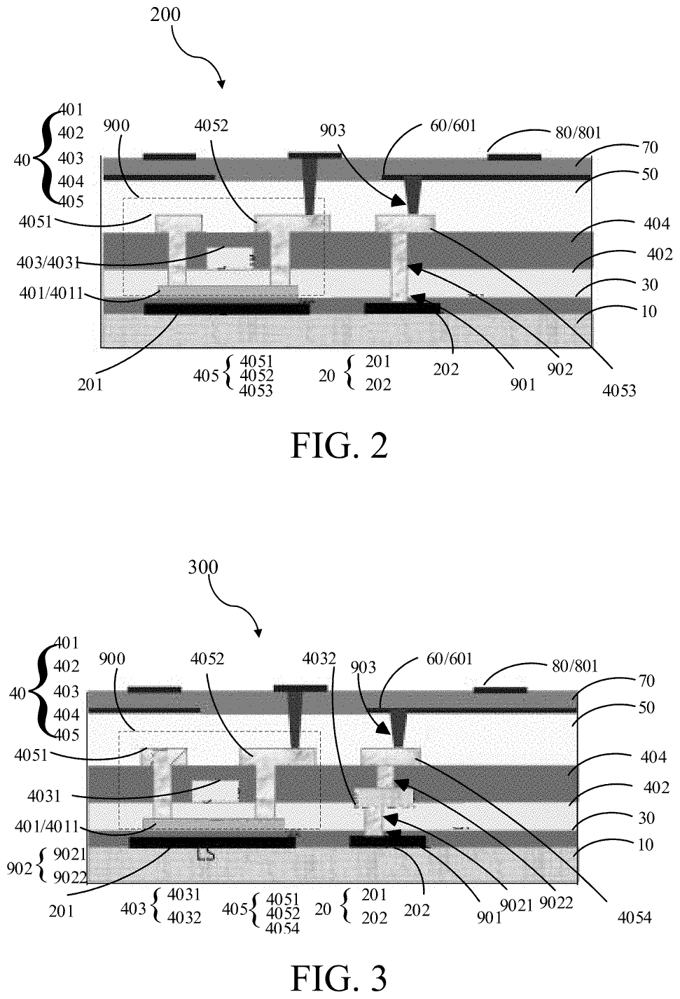

With reference to FIG. 2, FIG. 2 is a second schematic structural view of the embodiment of the embedded touch display panel of the present invention. A difference between the embedded touch panel 200 as shown in FIG. 2 and the embedded touch display panel 100 as shown in FIG. 1 lies in that the source/drain electrode metal sub-layer 405 is further configured to form a plurality of first connection electrodes 4053.

The first connection electrodes 4053 extend in the second via holes 902 and the first via holes 901, and are electrically connected to the touch wires 202 respectively. The multiplexing metal pieces 601 extend in the third via holes 903, and are electrically connected to the first connection electrodes 4053. It can be understood that, the first via holes 901 and the second via holes 902 are arranged coaxially, and the first via holes 901 and the second via holes 903 are arranged non-coaxially.

For instance, in an embodiment of the present invention, forms a light shielding metal layer 20 on a substrate 10, and forms a light shielding metal 201 and a plurality of metal wires 202 by a patterning process. Then, a conductive channel sub-layer 401, a third insulation sub-layer 402, a gate electrode metal sub-layer 403, and a fourth insulation sub-layer 404 are formed sequentially, and first via holes 901 and second via holes 902 are defined by an etching process. Then, a source/drain electrode metal sub-layer 405 is formed, and a plurality of first connection electrodes 4053 are formed by the patterning process; Then, a second insulation layer 50 is formed, and a plurality of third via holes 903 are defined by the etching process. Finally, a multiplexing electrode layer 60 is formed, and a plurality of multiplexing metal pieces 601 are formed by a patterning process. Because each of the multiplexing metal pieces 601 corresponds to one third via hole 903, therefore each of the multiplexing metal pieces 601 extends in the third via hole 903, to achieve an electrical connection to a corresponding first connection electrode 4053. Similarly, because each of the first connection electrodes 4053 corresponds to one first via hole 901 and one second via hole 902, therefore each of the first connection electrodes 4053 extends in the first via hole 901 and the second via hole 902 to achieve an electrical connection to a corresponding touch wire 202.

With reference to FIG. 3, FIG. 3 is a third schematic structural view of the embedded touch display panel of the embodiment in the present invention. Difference of the embedded touch panel 300 as shown in FIG. 3 from the embedded touch display panel 100 as shown in FIG. 1 lies in that the source/drain electrode metal sub-layer 405 is further configured to form a plurality of second connection electrodes 4054, and the gate electrode metal sub-layer 403 is further configured to form a plurality of third connection electrodes 4032.

The second via holes 902 include a plurality of first sub-via holes 9021 and a plurality of second sub-via holes 9022. The first sub-via holes 9021 are defined in the third insulation sub-layer 402. The second sub-via holes 9022 are defined in the fourth insulation sub-layer 404. Each of the multiplexing metal pieces 601 is electrically connected to a corresponding one of the touch wires 202 through the first via holes 901, the first sub-via holes 9021, the second sub-via holes 9022, and the third via holes 903.

The second connection electrodes 4054 extend in the second sub-via holes 9022 and are electrically connected to the third connection electrodes 4032. The third connection electrodes 4032 extend in first sub-via holes 9021 and the first via holes 901, and are electrically connected to the touch wires 202 respectively. The multiplexing metal pieces 601 extend in the third via holes 903, and are electrically connected to the second connection electrodes 4053. It can be understood that the third via holes 903, the second sub-via holes 9022, and the first sub-via holes 9021 are arranged non-coaxially, and the first sub-via holes 9021 and the first via holes 901 are arranged coaxially.

For instance, an embodiment of the present invention forms a light shielding metal layer 20 on a substrate 10, and forms a light shielding metal 201 and a plurality of metal wires 202 by a patterning process. Then, a conductive channel sub-layer 401 and a third insulation sub-layer 402 are formed sequentially, and first via holes 901 and first sub-via holes 9021 are defined by an etching process. Then, a gate electrode metal sub-layer 403 is formed, and a plurality of third connection electrodes 4032 are formed by a patterning process. Then, a fourth insulation sub-layer 404 is formed, and second sub-via holes 9022 are defined by an etching process. Then, a source/drain electrode metal sub-layer 405, and a plurality of second connection electrodes 4053 are formed by the patterning process. Then, a second insulation layer 50 is formed, and third via holes 903 are defined by the etching process. Finally, a multiplexing electrode layer 60 is formed, and a plurality of multiplexing metal pieces 601 are formed by the patterning process. Because each of the multiplexing metal pieces 601 corresponds to one third via hole 903, therefore each of the multiplexing metal pieces 601 extends in the third via hole 903 to be electrically connected to a corresponding second connection electrode 4053. Similarly, because each of the second connection electrodes 4053 corresponds to one second sub-via hole 9022, therefore each of the second connection electrodes 4053 extends in one second sub-via hole 9022 to be electrically connected to a corresponding third connection electrode 4032. Similarly, because each of the third connection electrodes 4032 corresponds to one first sub-via hole 9021 and one first via hole 901, therefore each of the third connection electrodes 4032 extends in the first sub-via hole 9021 and the first via hole 901 to achieve an electrical connection to a corresponding touch wire 202.

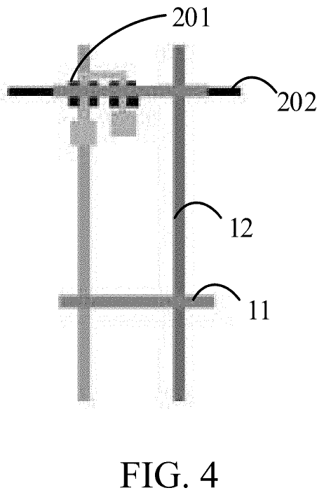

In an embodiment, with reference to FIGS. 4, 5, 6 and 7. FIG. 4 is a first schematic structural view of a wire layout structure of the embodiment of the embedded touch display panel of the present invention;

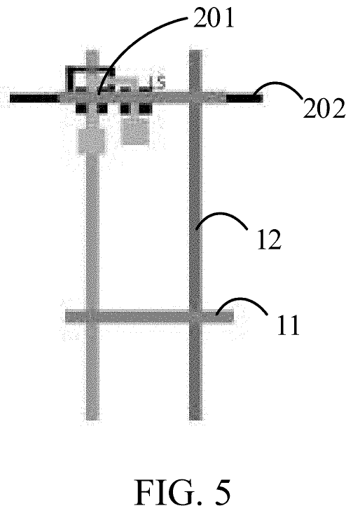

FIG. 5 is a second schematic structural view of the wire layout structure of the embodiment of the embedded touch display panel of the present invention;

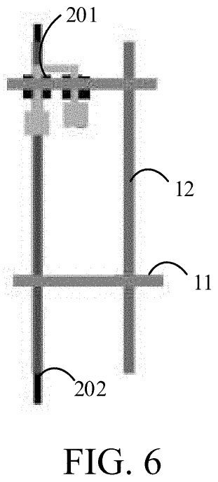

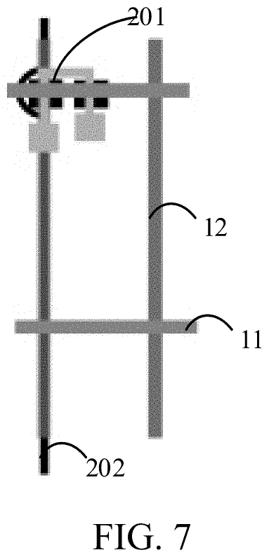

FIG. 6 is a third schematic structural view of the wire layout structure of the embodiment of the embedded touch display panel of the present invention; and FIG. 7 is a fourth schematic structural view of the wire layout structure of the embodiment of the embedded touch display panel of the present invention. As shown in FIGS. 4, 5, 6 and 7, the embedded touch display panel further includes a plurality of scan lines 11 and a plurality of data lines 12. The touch wires 202 can be disposed right under the data lines 12 or right under the scan lines 11 to increase pixel aperture ratio. The touch wires 202 can be attached to or detached from the light shielding metal 201.

In an embodiments, touch wires can be disposed on a side paralleling the data lines or the scan lines instead of being disposed right under the data lines or the scan lines.

The embedded touch display panel and the display device provided by the present invention comprise a substrate; a light shielding metal layer, the light shielding metal layer disposed on the substrate, the light shielding metal layer comprising a light shielding metal and a plurality of touch wires; and a multiplexing electrode layer disposed on the light shielding metal layer, and the multiplexing electrode layer comprises a plurality of multiplexing metal pieces, the plurality of multiplexing metal pieces are electrically connected to a plurality of touch wires respectively. The present invention, by disposing the touch wires and the light shielding metal on the same player, reduces a number of masks during forming the touch wires. In the present invention, the touch wires are also disposed right under scan lines or data lines to raise pixel aperture ratio.

The embodiment of the present invention also provides a display device including the embedded touch display panels of the abovementioned embodiments, details thereof can refer to the descriptions above and will be described repeatedly herein.

The embedded touch display panel and display device provided by the embodiments of the present invention are described in details as above. Specific examples are used herein to explain the principle and embodiment of the present invention. The description of the above embodiments is only configured to help understand the present invention. Meanwhile, for a person of ordinary skill in the art, according to the idea of the present invention, changes in the specific embodiment and application scope can be made. As described above, the contents of the specification should not be deemed as limitations to the present invention.

What is claimed is:

1. An embedded touch display panel, comprising:
a substrate;
a light shielding metal layer, the light shielding metal layer disposed on the substrate, and the light shielding metal layer comprising a light shielding metal and a plurality of touch wires; and
a multiplexing electrode layer, the multiplexing electrode layer disposed on the light shielding metal layer, and the multiplexing electrode layer comprising a plurality of multiplexing metal pieces, and the multiplexing metal pieces electrically connected to the touch wires respectively; and
wherein a first insulation layer, a transistor layer, and a second insulation layer are disposed between the light shielding metal layer and the multiplexing electrode layer, and are sequentially stacked upon one another;
wherein a plurality of first via holes are defined in the first insulation layer, a plurality of second via holes are defined in the transistor layer, a plurality of third via holes are defined in the second insulation layer, and each of the multiplexing metal pieces is electrically connected to a corresponding one of the touch wires through one of the first via holes, one of the second via holes, and one of the third via holes; and
wherein the embedded touch display panel further comprises a plurality of scan lines and a plurality of data lines, and the touch wires are disposed right under the scan lines or the data lines.

2. The embedded touch display panel as claimed in claim 1, wherein the multiplexing metal pieces extend in the first via holes, the second via holes, and the third via holes, and are electrically connected to the touch wires respectively.

3. The embedded touch display panel as claimed in claim 2, wherein the first via holes, the second via holes, and the third via holes are arranged coaxially.

4. The embedded touch display panel as claimed in claim 1, wherein
the transistor layer comprises a conductive channel sub-layer, a third insulation sub-layer, a gate electrode metal sub-layer, a fourth insulation sub-layer, and a source/drain electrode metal sub-layer that are sequentially stacked upon one another; and
the conductive channel sub-layer is configured to form a conductive channel of a transistor, the gate electrode metal sub-layer is configured to form a gate electrode of the transistor, the source/drain electrode metal sub-layer is configured to form a source electrode and a drain electrode of the transistor;
and the light shielding metal is located right under the transistor.

5. The embedded touch display panel as claimed in claim 4, wherein
the source/drain electrode metal sub-layer is further configured to form a plurality of first connection electrodes, the first connection electrodes extend in the second via holes and the first via holes, and are electrically connected to the touch wires respectively; and
the multiplexing metal pieces extend in the third via holes, and are electrically connected to the first connection electrodes respectively.

6. The embedded touch display panel as claimed in claim 5, wherein the first via holes and the second via holes are arranged coaxially, and the first via holes and the second via holes are arranged non-coaxially.

7. An embedded touch display panel, comprising:
a substrate;
a light shielding metal layer, the light shielding metal layer disposed on the substrate, and the light shielding metal layer comprising a light shielding metal and a plurality of touch wires; and
a multiplexing electrode layer, the multiplexing electrode layer disposed on the light shielding metal layer, and the multiplexing electrode layer comprising a plurality of multiplexing metal pieces, and the multiplexing metal pieces electrically connected to the touch wires respectively.

8. The embedded touch display panel as claimed in claim 7, wherein
a first insulation layer, a transistor layer, and a second insulation layer are disposed between the light shielding metal layer and the multiplexing electrode layer, and are sequentially stacked upon one another; and
a plurality of first via holes are defined in the first insulation layer, a plurality of second via holes are defined in the transistor layer, a plurality of third via holes are defined in the second insulation layer, and each of the multiplexing metal pieces is electrically connected to a corresponding one of the touch wires through one of the first via holes, one of the second via holes, and one of the third via holes.

9. The embedded touch display panel as claimed in claim 8, wherein the multiplexing metal pieces extend in the first via holes, the second via holes, and the third via holes and are electrically connected to the touch wires respectively.

10. The embedded touch display panel as claimed in claim 9, wherein the first via holes, the second via holes and the third via holes are arranged coaxially.

11. The embedded touch display panel as claimed in claim 8, wherein
the transistor layer comprises a conductive channel sub-layer, a third insulation sub-layer, a gate electrode metal sub-layer, a fourth insulation sub-layer, and a source/drain electrode metal sub-layer that are sequentially stacked upon one another; and
the conductive channel sub-layer is configured to form a conductive channel of a transistor, the gate electrode metal sub-layer is configured to form a gate electrode of the transistor, the source/drain electrode metal sub-layer is configured to form a source electrode and a drain electrode of the transistor; and the light shielding metal is located right under the transistor.

12. The embedded touch display panel as claimed in claim 11, wherein
the source/drain electrode metal sub-layer is further configured to form a plurality of first connection electrodes, the first connection electrodes extend in the second via holes and the first via holes, and are electrically connected to the touch wires respectively; and
the multiplexing metal pieces extend in the third via holes, and are electrically connected to the first connection electrodes respectively.

13. The embedded touch display panel as claimed in claim 12, wherein the first via holes and the second via holes are arranged coaxially, and the first via holes and the second via holes are arranged non-coaxially.

14. The embedded touch display panel as claimed in claim 11, wherein
the second via holes comprise a plurality of first sub-via holes and a plurality of second sub-via holes, the first sub-via holes are defined in the third insulation sub-layer, the second sub-via holes are defined in the fourth insulation sub-layer; and
each of the multiplexing metal pieces is electrically connected to a corresponding one of the touch wires through the first via holes, the first sub-via holes, the second sub-via holes and the third via holes.

15. The embedded touch display panel as claimed in claim 14, wherein
the source/drain electrode metal sub-layer is further configured to form a plurality of second connection electrodes, and the gate electrode metal sub-layer is further configured to form a plurality of third connection electrodes;
the second connection electrodes extend in the second sub-via holes and are electrically connected to the third connection electrodes, and the third connection electrodes extend in the first sub-via holes and are electrically connected to the touch wires respectively; and
the multiplexing metal pieces extend in the third via holes, and are electrically connected to the second connection electrodes.

16. The embedded touch display panel as claimed in claim 15, wherein the third via holes, the second sub-via holes and the first sub-via holes are arranged non-coaxially, and the first sub-via holes and the first via holes are arranged coaxially.

17. The embedded touch display panel as claimed in claim 7, wherein the embedded touch display panel further comprises a plurality of scan lines and a plurality of data lines; the touch wires are disposed right under the scan lines or the data lines.

18. The embedded touch display panel as claimed in claim 7, wherein the light shielding metal is insulated from the touch wires.

19. The embedded touch display panel as claimed in claim 7, wherein the light shielding metal is electrically connected to some of the touch wires.

20. A display device comprising an embedded touch display panel, and the embedded touch display panel comprising:
a substrate;
a light shielding metal layer, the light shielding metal layer disposed on the substrate, and the light shielding metal layer comprising a light shielding metal and a plurality of touch wires; and
a multiplexing electrode layer, the multiplexing electrode layer disposed on the light shielding metal layer, and the multiplexing electrode layer comprising a plurality of multiplexing metal pieces, and the multiplexing metal pieces electrically connected to the touch wires respectively.
